(19) United States
(12) Patent Application Publication
(10) Pub. No.: US 2004/0117461 A1
(43) Pub. Date: Jun. 17, 2004

(54) Download system and downloading device

(75) Inventors: Toshihiro Nakayama, Saitama-ken (JP); Katsuyoshi Suzuki, Tokyo (JP); Shintaro Nakamura, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/728,823

(22) Filed: Dec. 8, 2003

(30) Foreign Application Priority Data
Dec. 9, 2002 (JP) 2002-357054

(51) Int. Cl. G06F 15/16

(52) U.S. Cl. 709/219

(57) ABSTRACT

A download system includes a contents server that stores a plurality of pieces of contents data, a downloading device that exchanges data with the contents server through a predetermined network, the downloading device being capable of downloading a desired one of the plurality of pieces of contents data, a terminal device detachably connected to the downloading device, the terminal device being capable of receiving the desired one of the plurality of pieces of contents data from the downloading device, and a database server that stores reservation information indicative of a piece of contents data reserved by a user of the terminal device. The database server can exchange data with the contents server. With this configuration, the contents server transmits contents data corresponding to the reservation information when the terminal device is connected to the downloading device, the downloading device transmitting the contents data to the terminal device.

### BACKGROUND OF THE INVENTION

The present invention relates to a download system in which data (e.g., contents data) is transmitted from a server to a terminal device, and to a downloading device employed in the download system.

Conventionally, portable terminal devices having a memory device for storing digital data have been known. The data stored in such a memory includes contents data to be displayed on a display of the portable terminal device. Users of the portable terminal devices may obtain such contents data for free and/or for value. An example of a system that allows the user of the portable terminal device to obtain the contents data for free or for value is disclosed in Japanese Patent Provisional Publication P2000-76542A.

According to the above-identified publication, the system is configured such that a downloading device is provided, in advance, inside a store such as a convenience store or a video store, which device is connectable with a portable terminal device. The downloading device is connected to a network such as the Internet or WAN (Wide Area Network) through which the downloading device is capable of downloading the data and storing the data in a memory provided therein.

The download system as described above is configured such that, by operating the downloading device, desired ones of various pieces of the downloadable contents data are selected, and then the selected pieces of the contents data are transmitted to the downloading device. That is, it is necessary to operate the downloading device for selection before the data is transmitted. Therefore, a period of time in which a user uses the downloading device tends to be relatively long. In particular, when a lot of people wait for using the downloading device, the users should wait very long period.

### SUMMARY OF THE INVENTION

The download system and the downloading device according to the present invention is advantageous in that, even when many people wait for using the downloading device, a waiting time period can be well reduced.

According to an aspect of the invention, there is provided a download system, which includes a contents server that stores a plurality of pieces of contents data, a downloading device that exchanges data with the contents server through a predetermined network, the downloading device being capable of downloading a desired one of the plurality of pieces of contents data, a terminal device detachably connected to the downloading device, the terminal device being capable of receiving the desired one of the plurality of pieces of contents data from the downloading device, and a database server that stores reservation information indicative of a piece of contents data reserved by a user of the terminal device, the database server being capable of exchanging data with the contents server. With this configuration, the contents server transmits contents data corresponding to the reservation information when the terminal device is connected to the downloading device, and the downloading device transmits the contents data received from the contents server to the terminal device.

Optionally, the reservation information may include date and time information indicative of date and time when contents data reserved by the user of the terminal device is downloadable, and the contents server may be configured to transmit the reserved contents data to the downloading device when current date and time is later than the date and time defined by the date and time information included in the reservation information.

Further optionally, a single content may include a plurality of pieces of contents data. The download system may be configured such that the reservation information may be generated for each of the plurality of pieces of the contents data when the user of the terminal device reserves downloading of the single contents. Dates and times indicated by the date and time information of the reservation information of the plurality of pieces of contents data constituting the single content are the same, respectively, and dates and times of the reservation information of the plurality of pieces of the contents are different for a plurality of pieces of the contents. Further, the contents server may be configured to transmit the contents data corresponding to the reservation information having the same date and time to the terminal device when the terminal device is connected to the downloading device.

Still optionally, the reservation information may include downloaded status information indicating whether each contents data has been downloaded by the user of the terminal device, and the contents server may be configured not to transmit the contents data to the downloading device when the downloaded status information of the reservation information indicates that the contents data has been downloaded by the user of the terminal device.

Optionally, a plurality of pieces of contents data constitute a single content, and the reservation information is generated when the user of the terminal device reserves the downloading of the single content with respect to each of the plurality of pieces of contents data. Further, the reservation information includes date and time information indicating date and time when the contents data has been reserved to be downloaded by the user and downloaded status information indicating whether the contents has been downloaded by the user of the terminal device. Further, the date and time information of the reservation information for the plurality of pieces of contents data constituting a certain content are identical, date and time information of the contents data constituting different contents are different from each other, and the contents server transmits all the contents data having the oldest date and time information of the reservation information from among the contents data constituting a plurality of contents.

In this case, the downloading device may be configured to transmit completion notification data notifying completion of the downloading to the contents server after the contents data has been transmitted to the terminal device.

In a particular case, the downloading device has a temporary storing area that temporarily stores the contents data, and the downloading device deletes the contents data stored in the temporary storing area after the contents data has been transmitted to the terminal device.

Further optionally, the terminal device may be configured to store user identification information to be used to identify the user. In this case, the downloading device may read the user identification information from the terminal device when the terminal device is connected to the downloading device and transmits the user identification information to the contents server, and the contents server retrieves the reservation information from the database server with reference to the user identification information.

Furthermore, the contents data includes audio data, and the terminal device includes a audio data reproducing device that reproduces audio signals from the audio data.

Optionally, the downloading device may transmit audio message data to the terminal device when there is no contents data to be downloaded, and the terminal device may reproduce an audio message based on the received audio message data.

Optionally or alternatively, the downloading device may transmit audio message data inquiring whether the contents data is to be downloaded to the terminal device before it downloads the contents data, and the terminal device may reproduce an audio message based on the received audio message data.

Optionally or alternatively, a plurality of pieces of contents data may constitute a single content, and the downloading device may generate audio data notifying the date and time when the contents has been downloaded to the terminal device after all of the plurality of pieces of contents data have been transmitted to the terminal device.

According to another aspect of the invention, there is provided a download system, including a contents server storing a plurality of pieces of contents data, a downloading device that exchanges data with the contents server through a predetermined network, the downloading device being capable of downloading a desired one of the plurality of pieces of contents data, and a terminal device detachably connected to the downloading device, the terminal device being capable of receiving the desired one of the plurality of pieces of contents data from the downloading device. In this case, the downloading device may have a temporary storing area that temporarily stores the contents data, and the downloading device may be configured to delete the contents data stored in the temporary storing area after the contents data has been transmitted to the terminal device.

According to a further aspect of the invention, there is provided a downloading device for a download system in which the downloading device downloads contents data from a contents server through a predetermined network, a terminal device capable of receiving the contents data from the downloading device being detachably connected to the downloading device, the downloading device having a temporary storage that temporarily stores the contents data downloaded from the contents server through the predetermined network, and a data deleting system that deletes the contents data stored in the temporary storage after the contents data has been transmitted to the terminal device.

According to another aspect of the invention, there is provided a downloading device for a download system in which the downloading device downloads contents data from a contents server through a predetermined network, a terminal device capable of receiving the contents data from the downloading device being detachably connected to the downloading device, user identification information used for identifying a user of the terminal device being stored in the terminal device, the downloading device having a retrieving system that retrieves the user identification information from the terminal device when the terminal device is connected to the downloading device, and a transmitting system that transmits the user identification information to the contents server before the downloading device downloads the contents data from the contents server.

According to a furthermore aspect of the invention, there is provided a downloading device for a download system in which the downloading device downloads contents data from a contents server through a predetermined network, a terminal device capable of receiving the contents data from the downloading device being detachably connected to the downloading device, the contents data including audio data, the terminal device including an audio signal reproducing device, the downloading device having an audio message data generating system that generates audio message data indicating there is no downloadable data when there is no downloadable contents data in the contents server, and a data transmitting system that transmits the audio message data generated by the audio message data generating system to the terminal device.

According to a further aspect of the invention, there is provided a downloading device for a download system in which the downloading device downloads contents data from a contents server through a predetermined network, a terminal device capable of receiving the contents data from the downloading device being detachably connected to the downloading device, the contents data including audio data, the terminal device including an audio signal reproducing device, the downloading device having an audio message data generating system that generates audio message data inquiring whether the contents data is to be downloaded before the downloading device downloads the contents data from the contents server, and a data transmitting system that transmits the audio message data generated by the audio message data generating system to the terminal device.

According to a furthermore aspect of the invention, there is provided a downloading device for a download system in which the downloading device downloads contents data from a contents server through a predetermined network, a terminal device capable of receiving the contents data from the downloading device being detachably connected to the downloading device, the contents data including audio data, the terminal device including an audio signal reproducing device, a plurality of pieces of contents data constitute a single content, the downloading device having an audio message data generating system that generates audio message data notifying the date and time when the contents has been downloaded to the terminal device after all of the plurality of pieces of contents data have been transmitted to the terminal device, and a data transmitting system that transmits the audio message data generated by the audio message data generating system to the terminal device.

### BRIEF DESCRIPTION OF THE ACCOMPANYING DRAWINGS

FIG. 1 schematically shows a configuration of a downloading system according to an embodiment of the invention;

FIG. 2 is a block diagram of an automatic downloading device;

FIG. 3 is a flowchart illustrating a downloading procedure executed in the downloading device according to the embodiment of the invention;

FIG. 4 is a flowchart illustrating a downloadable date/time obtaining procedure called in the procedure shown in FIG. 3;

FIG. 5 is a flowchart illustrating an audio file storing procedure called in the procedure shown in FIG. 3;

FIG. 6 is a flowchart illustrating a downloadable date/time obtaining procedure executed by a contents server;

FIG. 7 is a flowchart illustrating a download list creating procedure executed in the contents server; and

FIG. 8 is a flowchart illustrating a notifying procedure in which completion of downloading is notified to a server.

### DESCRIPTION OF THE EMBODIMENT

Hereinafter, referring to the accompanying drawings, a download system according to an embodiment of the invention will be described.

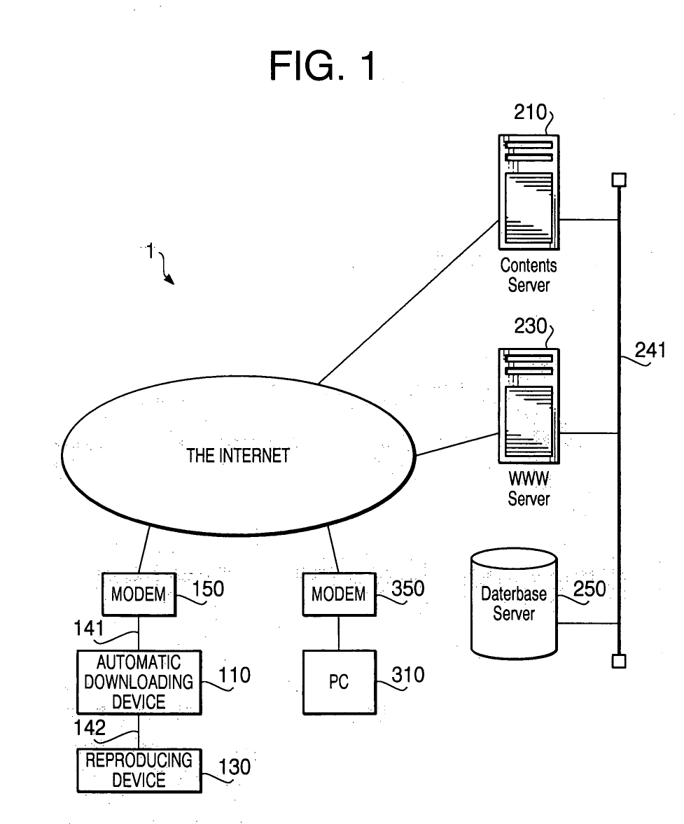

FIG. 1 shows a configuration of an automatic download system 1 according to an embodiment of the invention. The download system 1 according to the embodiment includes an automatic downloading device 110, a reproducing device 130, a contents server 210, a WWW (world wide web) server 230, and a database server 250. The WWW server 230 and the contents server 210 are directly connected to the Internet, so that data can be transmitted/received to/from host devices on the Internet. The contents server 210, the WWW server 230 and the database server 250 are connected to a LAN (Local Area Network) 241. The database server 250, the WWW server 230 and the contents server 210 can exchange data through the LAN 241.

The downloading device 110 is connected with a modem 150 through a LAN cable 141. The modem 150 is configured such that a dial-up connection can be established with the Internet through a public telephone line. The downloading device 110 can transmit/receive data with another host device on the Internet, through the modem 150.

The reproducing device 130 can be detachably connected to the downloading device 110 through a USB cable 142.

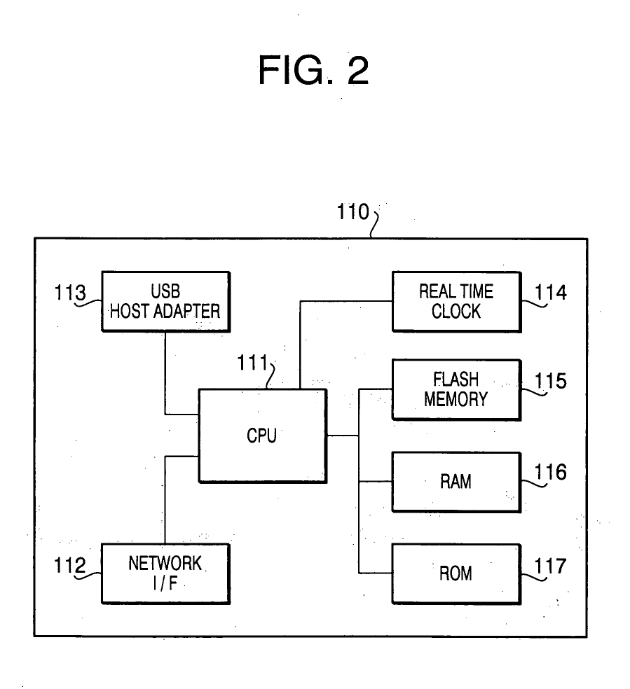

The contents server 210 includes, in the example, a plurality of audio data files in a storage thereof. According to a predetermined condition, the contents server 210 transmits the audio data files to the downloading device 110. The audio data files downloaded by the downloading device 110 are temporarily stored in a flash memory 115 (see FIG. 2) in the downloading device 110. The audio data files stored in the flash memory are transmitted to the reproducing device 130. After the transmission from flash memory to the reproducing device, the data file corresponding to the transferred audio data file is deleted from the flash memory 115. The reproducing device 130 reproduces an audio signal from the audio data file as transferred.

Generally, most of the audio data files are provided as pay data. According to the embodiment, a user of the reproducing device 130 transmits, in advance, order data for ordering contents to the WWW server 230 using a PC (personal computer) 310 which is connected to the Internet through a modem 350. The WWW server 230 transmits the order data as received to the database server 250. Then, the database server 250 generates a reservation record based on the transmitted order data, which will be described in detail. In accordance with the thus generated reservation record, the contents server 210 transmits the audio data to the downloading device 110.

As described above, the audio data file transmitted and stored in the flash memory 115 of the downloading device 110 is deleted after transmitted to the reproducing device 130. Therefore, the audio data file in the downloading device 110 downloaded from the contents server 210 can be reproduced only by the reproducing device 130 that is connected to the downloading device 110 when the data is downloaded.

FIG. 2 is a block diagram of the automatic downloading device 110. The downloading device 110 has, as shown in FIG. 2, a CPU (Central Processing Unit) 111, a network interface 112, a USB host adapter 113, a real time clock 114, the flash memory 115, a RAM (Random Access Memory) 116 and a ROM (Read Only Memory) 117.

The USB host adapter 113 includes a USB connecter (not shown), with which the USB cable 142 is connected. The CPU 111 controls the USB host adapter 113 to transmit/receive data with respect to the reproducing device 130.

The network interface 112 has a network terminal (not shown), to which the LAN cable 141 is connected. The CPU 111 controls the network interface 112 to transmit/receive data with respect to the modem 150.

The real time clock 114 is a device that outputs a current date and a current time. The CPU 111 controls the real time clock 114 to obtain precise data and time.

The flash memory 115 is an electrically erasable and rewritable non-volatile memory, in which data such as a network setting file is stored. The RAM 116 is a rewritable memory enabling a high-speed access thereto. The RAM 116 is used mainly as a work memory for the CPU 111. The ROM 117 stores various programs to be executed by the CPU 111.

The CPU 111 executes programs stored in the ROM 117, and downloads audio data related to the contents that was ordered by the user of the reproducing device 130 in advance from the contents server 120 through the network interface 112. The CPU 111 transmits the audio data to the reproducing device 130 through the USB host adapter 113.

A format of the reservation record stored in the database server 250 will be described. The reservation record includes seven items, which are: “UserID”, “Password”, “URL”, “File Name”, “File ID”, “Download available date and time” and “Download Status”. It should be noted that the reservation record is created for each of the audio data files constituting the contents reserved by the user. That is, when the user reserves certain contents which require a plurality of audio files, the reservation record is created for each of the plurality of the audio files.

The “UserID” and “Password” are the ID and password of the user who reserved the contents including the audio data file indicated by the reservation record. The “URL” indicates a location where the audio data file is stored, and the “File Name” is the name of the audio data file. The “File ID” indicates an ID code assigned to each audio data file. The “File ID” is used for managing of the reservation records and the audio data files by the data base server 250 and the contents server 210.

The “Download available date and time” indicates the date and time when the contents including the audio data files can be downloaded. It should be noted that the “Download available date and time” of the reservation records for the same contents are identical. Note that the “Downloading Start Date and Time” for respective contents are different from each other. Therefore, the “Downloading available Date and Time” can be regarded as the ID for specifying respective contents indicated by the reservation records.

Further, the “Download Status” takes a value of “Not Yet” or “Done”, which indicates whether the audio data file corresponding to the reservation record is transmitted to the reproducing device 130. That is, when the “Download Status” is “Not Yet”, the audio data file has not yet been transmitted to the reproducing device 130, while when the “Download Status” is “Done”, the audio data has been transmitted to the reproducing device 130.

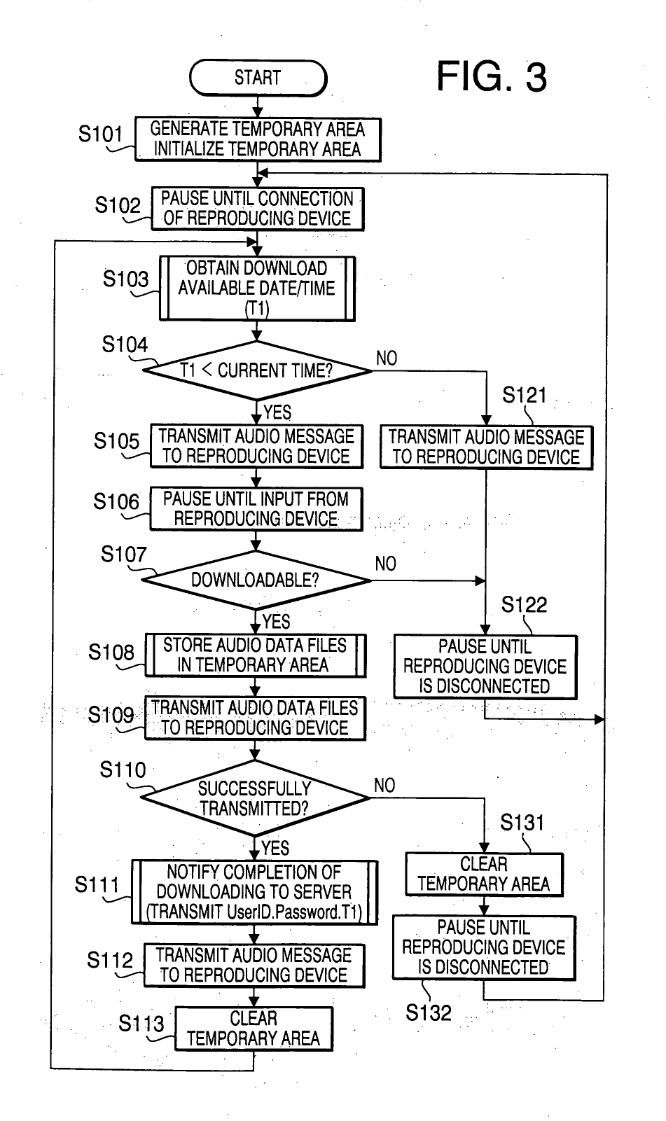

Next, an operation of the automatic downloading device 110 is described with reference to a flowchart shown in FIG. 3. The procedure shown in FIG. 3 is started when the power is supplied to the automatic downloading device 110.

When the procedure is started, in S101, a temporary area is defined in the RAM 116 and is initialized.

In S102, control pauses until the reproducing device 130 is connected to the downloading device 110. When the reproducing device 130 is connected, control proceeds to S103. If the reproducing device 130 has been connected to the downloading device 110 when the downloading device 110 is turned on, control skips S102.

In S103, a subroutine of “Download available date and time obtaining procedure” is called. In this subroutine, the downloading device 110 connects to the contents server 210, and transmits a request command to the contents server 210 to request for the download available time and date T1 which is the oldest one of the available dates and times of the contents which have been ordered but not yet downloaded. The contents server 210 controls the database server 250 to obtain T1 upon receipt of the command, and transmits the date and time T1 thus obtained to the automatic downloading device 110. According to the embodiment, the available date and time T1 differs for different contents, and therefore, the contents having the same available date and time T1 can be identified among the contents.

In S104, the date and time T1 thus obtained are compared with current date and time. When the current date and time is later than the obtained date and time T1 (S104: YES), control proceeds to S105.

In S105, audio data is used to ask an operator of the reproducing device 130 whether the operator intends to download the contents and store the same in the reproducing device 130. When the reproducing device 130 receives the thus transmitted audio data, it reproduces the same immediately. Then, the operator of the reproducing device 130 operates the reproducing device 130 to transmit a signal indicative of “to download” or “not to download” to the automatic downloading device 110.

In S106, control pauses until it receives the above-described signal from the reproducing device 130. When the downloading device 110 receives the signal from the reproducing device 130, control proceeds to S107.

In S107, the CPU evaluates the signal received from the reproducing device 130. If the received signal indicates “to download the contents”, control proceeds to S108.

In S108, a subroutine of “storing audio file in temporary area” is executed, in which the automatic downloading device 110 downloads all the audio data related to the contents from the contents server 210, and stores the same in the temporary area. Thereafter, control proceeds to S109.

In S109, all the data files stored in the temporary area are transmitted to the reproducing device 130.

In S110, the automatic downloading device 110 determines whether the transmission of the audio data files to the reproducing device 130 has been done successfully. When it is determined that the transmission was successful (S110: YES), control proceeds to S111.

In S111, the downloading device 110 executes a subroutine “notifying completion of downloading”. The subroutine is for notifying the contents server 210 that the transmission of the audio data files to the reproducing device 130 has been completed successfully. The contents server 210 transmits a command for setting the “downloaded status” of the reservation record of the audio files constituting the contents to “done” to the database server 250 when it determines, based on the notification, that the transmission was successfully completed. Upon receipt of the above command, the database server 250 rewrites the “downloaded status” of the reservation record. After the execution of the subroutine “notifying completion of downloading”, control proceeds to S112.

In S112, the downloading device 110 generates audio data notifying the date and time when the downloading of the contents has been completed, and transmits the same to the reproducing device 130. The reproducing device 130 is configured to reproduce the audio data thus transmitted in accordance with the operation of the user of the reproducing device 130. Therefore, the user of the reproducing device 130 can reproduce the audio data notifying the completion of the downloading sequentially to generate a download history of contents in the reproducing device 130.

In S113, the data stored in the temporary area is deleted. Then, control returns to S103, where it is determined whether there is any other content to be downloaded.

In S104, if the data and time T1 are equal to or later than the current date and time (S104: NO), control proceeds to S121. In S121, the downloading device 110 transmits an audio message notifying that there is no content that can be downloaded to the reproducing device 130. The reproducing device 130 reproduces the audio message upon receipt of the same, so that it is notified to the user of the reproducing device 130 immediately.

In S122, the downloading device 110 pauses until the reproducing device 130 is disconnected from the downloading device 110. When the reproducing device 130 is disconnected from the downloading device 110, control returns to S102.

In S110, if the transmission of the audio data files was failed as, for example, the reproducing device 130 was disconnected from the downloading device 110 (S110: NO), control proceeds to S131.

In S131, the data stored in the temporary area is deleted, and control proceeds to S132.

In S132, control pauses until the reproducing device 130 is disconnected from the downloading device 110. When the reproducing device 130 is or has been disconnected from the downloading device 110, control returns to S102. In this case, the downloading device 110 has not yet notified the contents server 210 of the successful completion of transmission of the audio data files to the reproducing device (i.e., S111 has not been called), the downloading operation is re-executed.

As described above, according to the procedure shown in FIG. 3, when the reproducing device 130 is connected to the downloading device 110, the downloading procedure is automatically executed and the audio data files constituting the downloadable contents are stored in the reproducing device 130. The audio data files are temporarily stored in the temporary area in the RAM 116 of the downloading device 110. However, after the audio data files have been stored in the reproducing device 130 or transmission the audio data files from the temporary area to the reproducing device 130 has been failed, the data files stored in the temporary area are deleted. Therefore, no data remains in the temporary area in the RAM 116. With this configuration, illegal usage of the audio data files by an unauthorized user who does not buy the contents can be prevented.

Further, according to the procedure described above, after the audio data files are stored in the reproducing device 130, a command for setting the “downloaded status” of the reservation record of the audio data files constituting the contents is transmitted to the database server 250. The database server 250 rewrites the “downloaded status” of the reservation record to “done” in response to the command. Therefore, the audio data files once downloaded successfully will not be downloaded in the reproducing device 130 when it is connected to the downloading device 110.

Furthermore, according to the procedure described above, when the transmission of the audio data files to the reproducing device 130 is failed, or the transmission was interrupted, for example, by the operation of the user, the “downloaded status” of the reservation record remains “not yet”. Therefore, in this case, when the reproducing device 130 is connected to the downloading device 110, the audio data files can be re-downloaded.

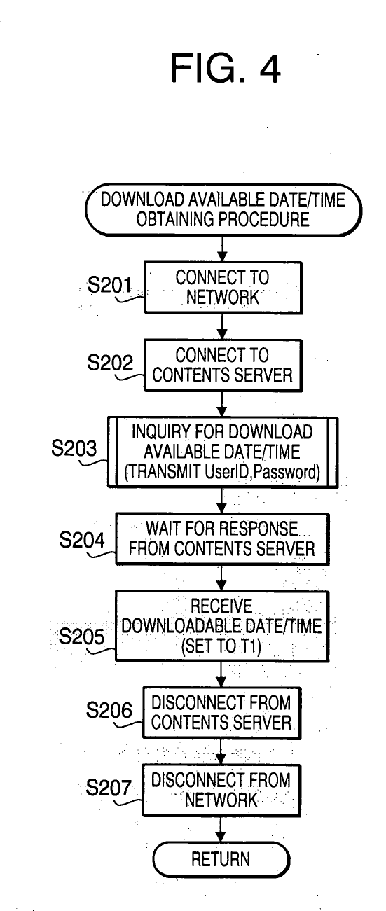

FIG. 4 is a flowchart illustrating the subroutine “download available date and time obtaining procedure” which is called in S103 of the procedure shown in FIG. 3.

When the procedure shown in FIG. 4 is called at S201, the CPU 111 controls the modem 150 through the network interface 112 to make a dial-up connection to the Internet. With this dial-up connection, the downloading device 110 can exchange data with another computer on the Internet.

In S202, the downloading device 110 accesses the contents server 210 in accordance with a predetermined protocol.

In S203, the downloading device 110 transmits the UserID and Password stored in the ROM of the reproducing device 130 to the contents server 210. The contents server 210 transmits inquiry to the database server 250 upon receipt of the UserID and Password to obtain the oldest one of the download available dates and times of the contents that were bought by the user identified by the UserID and the Password, and have not yet downloaded by the user. The thus obtained date and time are transmitted to the downloading device 110.

In S204, the downloading device 110 pauses until the download available date and time are transmitted by the contents server 210. After the download available date and time are received from the contents server 210, control proceeds to S205.

In S205, the download available date and time are set to the variable T1.

In S206, the downloading device 110 stops communicating with the contents server 210.

In S207, the CPU 111 controls the modem 150 through the network interface 112 to stop the dial-up connection with the Internet. Then, the procedure shown in FIG. 4 is finished, and control returns to the procedure shown in FIG. 3 (to S104).

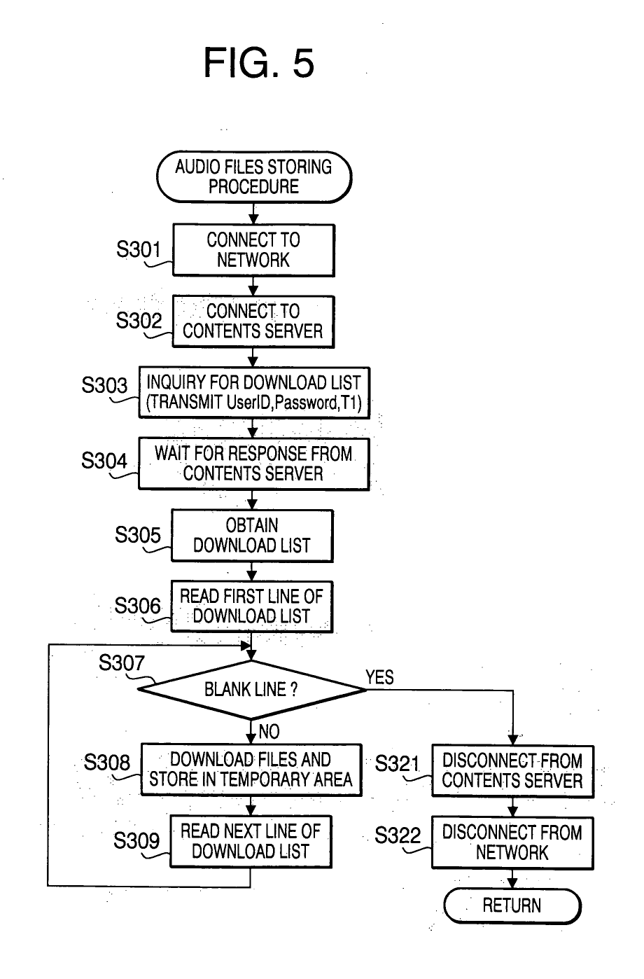

FIG. 5 is a flowchart of the subroutine “storing audio files in temporary area” which is called in S108 of the procedure shown in FIG. 3.

In S301, the CPU 111 controls the modem 150 through the network interface 112 to make a dial-up connection to the Internet. With this connection, the downloading device 110 can exchange data with another computer on the Internet.

In S302, the downloading device 110 connects with the contents server 210 in accordance with a predetermined protocol.

In S303, the downloading device 110 transmits the UserID and the Password stored in the ROM of the reproducing device 130, and the download available date and time T1 obtained in S103 (see FIG. 3) to the contents server 210.

When the UserID, Password and the download available date and time T1 are received, the contents server 210 transmits an inquiry to the database server 250 to obtain a download list, which is a list of URLs and file names of audio data files constituting the contents bought by the user identified by the UserID and the Password and the download available date and time are T1, and the download list is transmitted from the contents server 210 to the downloading device 110. The download list includes a URL of the audio download file in each line. That is, the number of the lines of the download list is equal to the number of the audio data files included in the contents.

In S304, the downloading device 110 waits for the download list transmitted from the contents server 210. Upon receipt of the download list from the contents server 210, control proceeds to S305.

In S305, the download list received in S304 is stored in the temporary area.

In S306, the first line of the download list it read and stored in a work area of the RAM 116.

In S307, it is determined whether the first line of the download list stored in the work area is blank or not. If the first line of the download list is not a blank (S307: NO), control proceeds to S308.

In S308, the CPU 111 requests the contents server 210 for the downloading of the audio data files having the file names and URLs included in the first line of the download list, and obtains the audio data files. The thus obtained audio data files are stored in the temporary area. Specifically, when the audio data files are obtained, the UserID and Password as well as the URLs and file names are transmitted to the contents server 210. Then the contents server 210 inquires the database server 250 to confirm that the audio data files belong to the contents bought by the user identified by the UserID and the Password. When the confirmation is successfully made, the audio data files are transmitted to the downloading device 110. Therefore, the audio data files will not be downloaded illegally by a user who did not buy the contents.

In S309, a succeeding line of the download list is read and stored in the work area of the RAM 116. Then control proceeds to S307.

In S307, if the line read and stored from the download list is a blank line (S307: YES), control proceeds to S321.

In S321, the downloading device 110 stops communicating with the contents server 210.

In S322, the CPU 111 controls the modem 150 via the network interface 112 to stop the dial-up connection with the Internet. After S322, the subroutine shown in FIG. 5 is finished, and control returns to the procedure shown in FIG. 3.

As described above, according to the subroutine, until a blank line is read, audio data files identified by the URL and file name described in the download list are stored in the temporary area. That is, all the audio data files identified by the URLs and file names in the download list are stored in the temporary area.

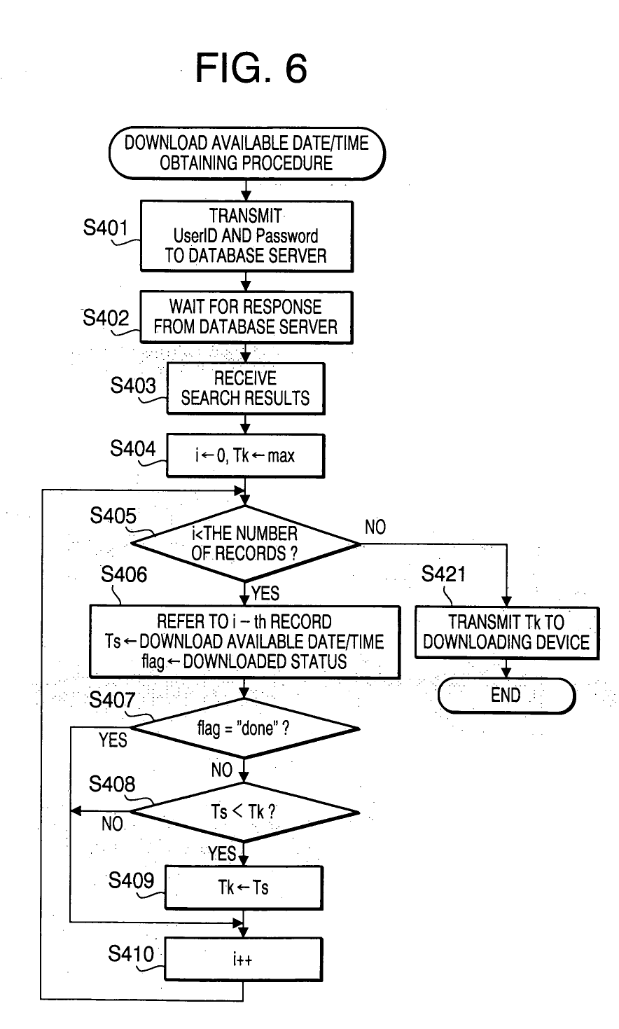

FIG. 6 is a flowchart illustrating a procedure executed by the contents server 210 when the downloading device 110 transmits the UserID and Password stored in the ROM of the reproducing device 130 to the contents server 210.

In S401, the contents server 210 transmits the UserID and Password, which are transmitted from the downloading device 110 (S203) to the database server 250 in order to obtain all the reservation records of the audio data files included in the contents bought by the user identified by the UserID and the Password.

In S402, the contents server 210 pauses until the database server 250 is ready to transmit the reservation records. When a response indicative that the database server 250 is ready to transmit the reservation records is received from the database server 250, control proceeds to S403.

In S403, the reservation records are received from the database server 250.

In S404, variables i and Tk are initialized the variable i denotes a counting value, and the variable Tk denotes date (and time). In this embodiment, the variable i is set to “0”, and the variable Tk is set to a date (e.g., Dec. 31, 2100) which would be later than any possible date and time when downloading becomes available.

In S405, the variable i and the number of the reservation records received in S403 are compared. If the variable i is smaller than the number of the reservation records (S405: YES), control proceeds to S406.

In S406, the “download available date and time” of an i-th reservation record is set to a variable Ts, and the “downloaded status” of the i-th reservation record is set to a flag.

In S407, the value of flag is checked. If the value of the flag is “not yet” (S407: NO), control proceeds to S408.

In S408, the variables Ts and Tk are compared. If the variable Ts is smaller than the variable Tk, that is, if the date and time represented by the variable Ts is earlier than the date and time represented by the variable Tk (S408: YES), control proceeds to S409.

In S409, the value of the variable Ts is used to set the variable Tk.

If, in S407, the value of the flag is “done” (S407: YES), or if the Ts is equal to or greater than Tk (S408: NO), control skips S409 and proceeds to S410. Thus, when the value of the flag is “done”, i.e., the audio data file corresponding to the record has been stored in the reproducing device 130, the value of the variable Ts is not used to set the variable Tk. Similarly, when the Ts is greater than Tk, i.e., when the current date and time is earlier than the download available date and time of the record, the value of the variable Ts is not set to the variable Tk.

In S410, the variable i is incremented by one, and then control proceeds to S405.

If the variable i is equal to the number of the reservation records received in S403 (S405: NO), control proceeds to S421.

In S421, the value of the variable Tk is transmitted to the downloading device 110 and the procedure shown in FIG. 6 is finished. The value of the variable Tk is set to the variable T1 in S205 of FIG. 4.

As described above, according to the procedure shown in FIG. 6, with the loop of steps S405 through S410, the download available date and time and the downloaded status of each of the reservation records received in S403 are examined. Further, from among reservation records corresponding to the audio data files which have not been downloaded in the reproducing device 130, one having the oldest download available date and time is extracted.

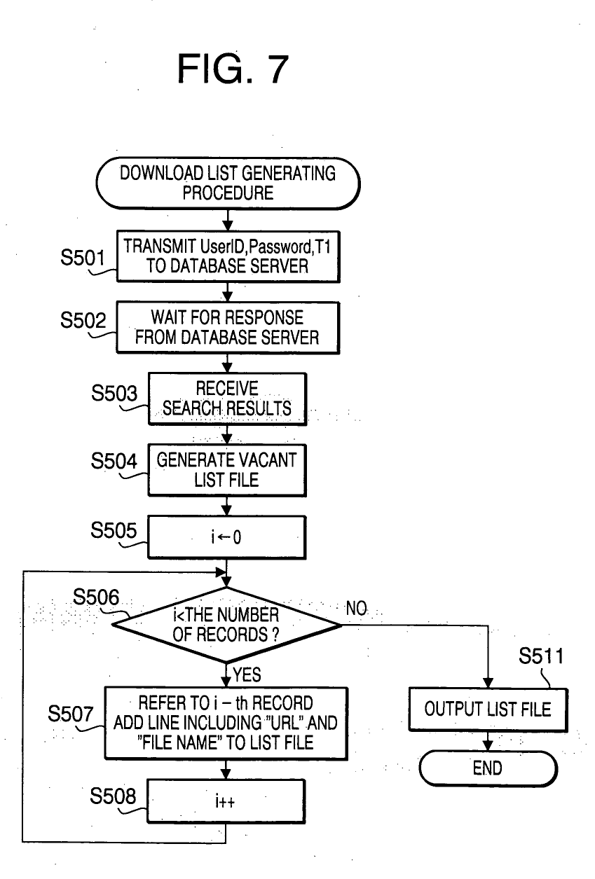

FIG. 7 is a flowchart illustrating a procedure executed by the contents server 210 when the downloading device 110 transmits the UserID and Password stored in the ROM of the reproducing device 130 and the date and time T1 obtained in S103 (FIG. 3) to the contents server 210.

In S501, the contents server 210 transmits the UserID, Password and the variable T1 received from the downloading device 110 to the database server 250 to obtain the reservation records of the audio data files included in the contents bought by the user identified by the UserID and the Password, and the download available date and time equal to T1. It should be noted that the contents have different download available dates and times, respectively, and the audio data files included in the same contents have the same download available date and time. Accordingly, the request issued in S501 requests for the reservation records for the audio data files included in the contents whose download available date and time equal to T1 (i.e., the contents which have not yet been downloaded) and having the oldest download available date and time which is earlier than the current date and time.

In S502, the contents server 210 pauses until the database server 250 is ready to transmit the reservation records. When the database server 250 is ready to transmit the reservation records, control proceeds to S503.

In S503, the contents server 210 receives the reservation records from the database server 250.

In S504, a vacant list file is generated. Then, in S505, the variable i is initialized (i.e., set to “0”).

In S506, the number of the reservation records received in S503 and the variable i are compared. If the number of the reservation records is larger than the variable i (S506: YES), control proceeds to S507.

In S507, the i-th URL and file name are converted into a line of character string. Then, the converted character string is added at the end of the list file with the line feed code at the end of the added line.

In S508, the variable i is incremented by one.

In S506, if the variable i is equal to or greater than the number of the reservation records (S506: NO), control proceeds to S511.

In S511, the list file generated in the loop of steps S506 through S508 is transmitted to the downloading device 110. The transmitted list file is received in S305 (FIG. 5) by the downloading device 110.

As described above, according to the procedure shown in FIG. 7, the URLs and file names of the all the reservation records are extracted, and a list file having the URL and the file name for each reservation record on each line is generated.

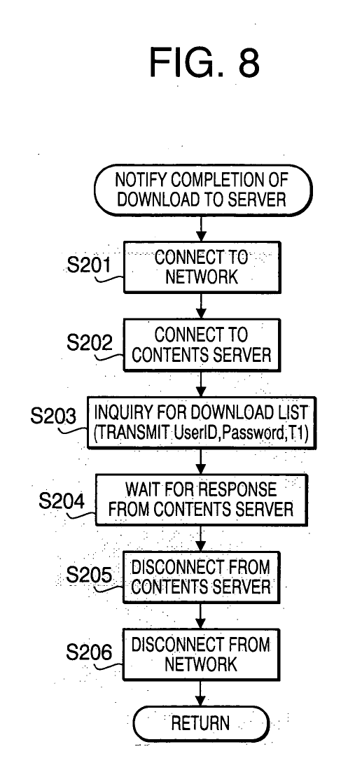

FIG. 8 is a flowchart illustrating a subroutine “download completion notifying procedure” which is called in S111 of FIG. 3 and executed by the downloading device 110.

In S601, the CPU 111 controls the modem 150 through the network interface 112 to make a dial-up connection with the Internet. With the dial-up connection, the downloading device 110 can exchange data with another computer on the Internet.

In S602, the downloading device 110 accesses the contents server 210 in accordance with a predetermined communication protocol.

In S603, the downloading device 110 transmits the UserID and Password stored in the ROM of the reproducing device 130 and the download available date and time T1 obtained in S103 of FIG. 3 to the contents server 210.

The contents server 210 transfers the UserID and the Password as received to the database server 250 to request that, for the records whose download available date and time is equal to T1 among the reservation records of the audio data files included in the contents which have been bought by the user who is identified by the UserID and the Password, the “downloaded status” is set to “done”. The database server 250, upon receipt of the request, set each “downloaded status” satisfying the above condition to “done”, and then transmits the updated results to the contents server 210. Upon receipt of the updated results from the database server 250, the contents server 210 transmits information notifying that the reservation records satisfying the above condition have been set to “done” to the downloading device 110.

In S604, the downloading device 110 pauses until it receives, from the contents server 210, the information notifying the reservation records satisfying the above condition have been set to “done”. After receiving the above information, control proceeds to S605.

In S605, the downloading device 110 terminates the communication with the contents server 210.

In S606, the CPU 111 controls the modem 150 through the network interface 112 to stop the dial-up communication, and terminates the procedure shown in FIG. 8.

As described above, according to the subroutine shown in FIG. 8, the reservation records stored in the database server 250 are updated, and the “downloaded status” of the reservation records of the audio data files constituting the downloaded contents are set to “done”.

As described above, according to the embodiment, even when the traffic is high, the queuing time of the user of the downloading device can be reduced.

The present disclosure relates to the subject matter contained in Japanese Patent Application No. 2002-357054, filed on Dec. 9, 2002, which is expressly incorporated herein by reference in its entirety.

What is claimed is:

1. A download system, comprising:
a contents server that stores a plurality of pieces of contents data;
a downloading device that exchanges data with said contents server through a predetermined network, said downloading device being capable of downloading a desired one of the plurality of pieces of contents data;
a terminal device detachably connected to said downloading device, said terminal device being capable of receiving the desired one of the plurality of pieces of contents data from said downloading device; and
a database server that stores reservation information indicative of a piece of contents data reserved by a user of said terminal device, said database server being capable of exchanging data with said contents server,
wherein said contents server transmits contents data corresponding to the reservation information when said terminal device is connected to said downloading device, and
wherein said downloading device transmits the contents data received from said contents server to said terminal device.

2. The download system according to claim 1,
wherein the reservation information includes date and time information indicative of date and time when contents data reserved by the user of said terminal device is downloadable, and
wherein said contents server transmits the reserved contents data to said downloading device when current date and time is later than the date and time defined by the date and time information included in the reservation information.

3. The download system according to claim 2,
wherein a plurality of pieces of contents data constitute a single content,
wherein the reservation information is generated for each of the plurality of pieces of the contents data when the user of said terminal device reserves downloading of the single contents,
wherein dates and times indicated by the date and time information of the reservation information of the plurality of pieces of contents data constituting the single content are the same, respectively,
wherein dates and times of the reservation information of the plurality of pieces of the contents are different for a plurality of pieces of the contents, and
wherein the contents server transmits the contents data corresponding to the reservation information having the same date and time to said terminal device when said terminal device is connected to said downloading device.

4. The download system according to claim 1,
wherein the reservation information includes downloaded status information indicating whether each contents data has been downloaded by the user of said terminal device, and
wherein said contents server does not transmit the contents data to said downloading device when the downloaded status information of the reservation information indicates that the contents data has been downloaded by the user of said terminal device.

5. The download system according to claim 1,
wherein a plurality of pieces of contents data constitute a single content,
wherein the reservation information is generated when the user of said terminal device reserves the downloading of the single content with respect to each of the plurality of pieces of contents data,
wherein the reservation information includes date and time information indicating date and time when the contents data has been reserved to be downloaded by the user and downloaded status information indicating whether the contents has been downloaded by the user of said terminal device,
wherein the date and time information of the reservation information for the plurality of pieces of contents data constituting a certain content are identical,
wherein date and time information of the contents data constituting different contents are different from each other,
wherein said contents server transmits all the contents data having the earliest date and time information of the reservation information from among the contents data constituting a plurality of contents.

6. The download system according to claim 4,
wherein said downloading device transmits completion notification data notifying completion of the downloading to said contents server after the contents data has been transmitted to said terminal device.

7. The download system according to claim 1,
wherein said downloading device has a temporary storing area that temporarily stores the contents data, and
wherein said downloading device deletes the contents data stored in said temporary storing area after the contents data has been transmitted to said terminal device.

8. The downloading system according to claim 1,
wherein said terminal device stores user identification information to be used to identify the user,
wherein said downloading device reads the user identification information from said terminal device when said terminal device is connected to said downloading device and transmits the user identification information to said contents server, and
wherein said contents server retrieves the reservation information from said database server with reference to the user identification information.

9. The download system according to claim 1,
wherein the contents data includes audio data, and
wherein said terminal device includes a audio data reproducing device that reproduces audio signals from the audio data.

10. The download system according to claim 9,
wherein said downloading device transmits audio message data to said terminal device when there is no contents data to be downloaded, and
wherein said terminal device reproduces an audio message based on the received audio message data.

11. The download system according to claim 9,
wherein said downloading device transmits audio message data inquiring whether the contents data is to be downloaded to said terminal device before it downloads the contents data, and
wherein said terminal device reproduces an audio message based on the received audio message data.

12. The download system according to claim 9,
wherein a plurality of pieces of contents data constitute a single content,
wherein said downloading device generate audio data notifying the date and time when the contents has been downloaded to said terminal device after all of the plurality of pieces of contents data have been transmitted to said terminal device.

13. A download system, comprising:
a contents server storing a plurality of pieces of contents data;
a downloading device that exchanges data with said contents server through a predetermined network, said downloading device being capable of downloading a desired one of the plurality of pieces of contents data; and
a terminal device detachably connected to said downloading device, said terminal device being capable of receiving the desired one of the plurality of pieces of contents data from said downloading device,
wherein said downloading device has a temporary storing area that temporarily stores the contents data, and
wherein said downloading device deletes the contents data stored in said temporary storing area after the contents data has been transmitted to said terminal device.

14. A downloading device for a download system in which said downloading device downloads contents data from a contents server through a predetermined network, a terminal device capable of receiving the contents data from said downloading device being detachably connected to said downloading device, said downloading device comprising:
a temporary storage that temporarily stores the contents data downloaded from the contents server through the predetermined network; and
a data deleting system that deletes the contents data stored in said temporary storage after the contents data has been transmitted to the terminal device.

15. A downloading device for a download system in which said downloading device downloads contents data from a contents server through a predetermined network, a terminal device capable of receiving the contents data from said downloading device being detachably connected to said downloading device, user identification information used for identifying a user of the terminal device being stored in the terminal device, said downloading device comprising:
a retrieving system that retrieves the user identification information from the terminal device when the terminal device is connected to said downloading device; and
a transmitting system that transmits the user identification information to the contents server before said downloading device downloads the contents data from the contents server.

16. A downloading device for a download system in which said downloading device downloads contents data from a contents server through a predetermined network, a terminal device capable of receiving the contents data from said downloading device being detachably connected to said downloading device, the contents data including audio data, the terminal device including an audio signal reproducing device, said downloading device comprising:
an audio message data generating system that generates audio message data indicating there is no downloadable data when there is no downloadable contents data in the contents server; and
a data transmitting system that transmits the audio message data generated by said audio message data generating system to the terminal device.

17. A downloading device for a download system in which said downloading device downloads contents data from a contents server through a predetermined network, a terminal device capable of receiving the contents data from said downloading device being detachably connected to said downloading device, the contents data including audio data, the terminal device including an audio signal reproducing device, said downloading device comprising:
an audio message data generating system that generates audio message data inquiring whether the contents data is to be downloaded before the downloading device downloads the contents data from the contents server; and
a data transmitting system that transmits the audio message data generated by said audio message data generating system to the terminal device.

18. A downloading device for a download system in which said downloading device downloads contents data from a contents server through a predetermined network, a terminal device capable of receiving the contents data from said downloading device being detachably connected to said downloading device, the contents data including audio data, the terminal device including an audio signal reproducing device, a plurality of pieces of contents data comprising a single content, said downloading device comprising:
an audio message data generating system that generates audio message data notifying the date and time when the contents has been downloaded to said terminal device after all of the plurality of pieces of contents data have been transmitted to said terminal device; and
a data transmitting system that transmits the audio message data generated by said audio message data generating system to the terminal device.
